(19) United States
(12) Patent Application Publication
(10) Pub. No.: US 2025/0246593 A1
(43) Pub. Date: Jul. 31, 2025

(54) METHOD FOR PREPARING A CATHODE MATERIAL FOR A BATTERY

(71) Applicant: COMMISSARIAT A L'ENERGIE ATOMIQUE ET AUX ENERGIES ALTERNATIVES, Paris (FR)

(72) Inventors: Mathieu COGNIARD, Grenoble Cedex 09 (FR); Yohan BIECHER, Grenoble Cedex 09 (FR); Jean-François COLIN, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/037,480

(22) Filed: Jan. 27, 2025

(30) Foreign Application Priority Data
Jan. 29, 2024 (FR) 2400824

(51) Int. Cl. H01M 4/04; H01M 4/02; H01M 4/1391; H01M 4/58; H01M 4/62

(52) U.S. Cl. CPC H01M 4/0404; H01M 4/1391; H01M 4/5825; H01M 4/622; H01M 2004/028

(57) ABSTRACT

The invention relates to a method for preparing a cathode material for a battery, comprising a step of obtaining this cathode material in the form of a mixture of so-called primary particles, with a monomodal size distribution and a volume mean diameter of less than or equal to 2 μm, then a step of shaping said mixture of primary particles by granulation by grinding in a ball mill, in a mixture of organic solvents comprising a polar organic solvent and an apolar organic solvent, the polar organic solvent and the apolar organic solvent being immiscible. The cathode material in particulate form thus obtained has a good electrochemical performance, a low reactivity and a high energy density.

The present invention relates to the field of manufacturing cathodes for batteries. More particularly, the present invention relates to a method for preparing a cathode material for a battery, as well as a method for manufacturing a cathode for a battery implementing such a method.

A particular field of application of the invention, although not limiting in any way, is that of the preparation of cathode materials for lithium-ion type batteries, in particular of the category of lithium-rich oxides with a disordered rocksalt structure. Such materials, which will be designated in the present description by the abbreviation DRS, which stands for “disordered rocksalt oxide”, generally comprise lithium, one or more transition metals and oxygen. The oxygen site can be doped, for example by fluorine, to improve the electrochemical performance of the material. Such materials may correspond to the general formula (I):

LiₓM¹_{y}M²_{z}O₃₋ᵤFᵤ (I)
wherein x is greater than 1 and less than 3, y is between 0 and 1, z is between 0 and 1, x, y and z being such that x+y+z=3,
u is between 0 and 1,
M¹ represents a first transition metal, such as manganese Mn, iron Fe, vanadium V or molybdenum Mo,
and M² represents a second transition metal different from said first transition metal, such as niobium Nb or titanium Ti.

Among these materials, those having a high fluorine content, for which, in the general formula (I), u is greater than or equal to 0.3, prove to be particularly advantageous from the standpoint of electrochemical performance. The technique most commonly used for the synthesis of these materials is mechanosynthesis, according to which suitable precursors of the material, such as LiF, Li₂CO₃, Li₂O, Mn₂O₃, TiO₂, Nb₂O₅, etc., are ground for several tens of hours at high speed in a planetary mill, in order to form a disordered rocksalt type phase.

Unlike lamellar cathode materials such as LiNiₓMn_{y}Co_{z}O₂ (NMC), the disordered cubic structure makes it possible to eliminate the need for cobalt and nickel, considerably lowering the cost of production of the material, while maintaining interesting performances.

When they are implemented as cathode material in an electrochemical cell, lithium-rich DRS materials have an experimental capacity greater than 250 mAh/g, at a discharge potential close to 3.4 V, which leads to an energy density of in the order of 900 Wh/kg on the material scale. On the scale of a complete cell, an energy density equivalent to or greater than that of the lithium-iron-phosphate (LFP) type material, i.e., 240 Wh/kg, is advantageously possible. The material corresponding to the formula Li₂MnO₂F, in particular, is one of the most promising materials among DRS synthesized by mechanosynthesis, because it delivers a capacity in the order of 270 mAh/g.

However, the mechanosynthesis technique does not make it possible to control the morphology of the particles of material that it makes it possible to obtain. This morphology is inhomogeneous, with a multimodal particle size distribution. This morphology of the particles of the post-synthesis material does not make it possible to obtain suitable electrochemical performances. Furthermore, it complicates the implementation of the material for manufacturing cathodes, because it induces the formation of grains during the step of coating the current collector by the material.

To remedy these drawbacks, it has been proposed by the prior art to reduce by grinding the size of the particles obtained at the end of the mechanosynthesis method, to a nanometric value, less than 1,000 nm. However, two barriers limit the use of such materials in pulverized form in complete electrochemical systems:
the cycle life is relatively short due to harmful phenomena occurring on the cathode surface, such as the degradation of the electrolyte and the densification of this surface;
the gravimetric energy density is greatly reduced on the scale of the electrochemical cell.

Thus, the pulverized morphology of the materials leads to increased reactivity, and to a loss of energy at the level of the electrochemical cell.

Documents WO 2022/121570, CN 102187502, CN 116779844 and U.S. Pat. No. 9,543,574 describe cathode materials in the form of secondary particles formed by an agglomeration of a plurality of primary particles. Documents WO 2014/140323 and KR 2017 0111740 also describe cathode materials in the form of secondary particles formed by an agglomeration of a plurality of primary particles, which are obtained by methods comprising a granulation step by grinding the primary particles in, respectively, water for the first, and an organic solvent such as a ketone or an alcohol optionally mixed with water for the second. None of these methods, however, makes it possible to obtain secondary particles with a substantially monomodal size distribution.

The aim of the present invention is to propose a method for preparing a cathode material for a battery, in particular of the lithium-rich DRS type, in particular with a high fluorine content, which makes it possible to obtain a cathode material in particulate form having both good electrochemical performance, in particular a good cycle life, low reactivity with respect to ambient air and the electrolyte used in the electrochemical cell, a high energy density and a controlled monomodal morphology.

Additional objectives of the invention are that this method is easy to implement, furthermore by means of equipment commonly available in production sites for cathode materials for batteries, and that the material which it makes it possible to obtain is easy to shape in the form of an electrode, in particular by a coating method which is conventional per se.

It has now been discovered by the inventors that these objectives can be achieved by a method comprising a step of granulating the material in pulverized form having been obtained by the conventional methods proposed by the prior art, this granulation step being carried out under specific conditions.

Thus, according to a first aspect, the present invention proposes a method for preparing a cathode material for a battery/accumulator, in particular, but not limitatively, of the lithium-ion type. This method comprises:
obtaining said cathode material in the form of a mixture of particles of said material, referred to as primary particles, with a substantially monomodal size distribution and a volume mean diameter, determined by laser diffraction, less than or equal to 2 μm, preferably less than or equal to 1 μm and more preferably less than or equal to 600 nm,
then, a step of shaping this mixture of primary particles by granulation by grinding in a ball mill, in a mixture of organic solvents comprising a polar organic solvent and an apolar organic solvent, said polar organic solvent and said apolar organic solvent being immiscible.

Preferably, the method of the invention comprises final steps of drying the particles formed, for example by evaporating under vacuum the organic solvents present in the medium, then of separating the particulate material obtained and the balls used for the grinding, for example by sieving.

The shaping step of the method of the invention advantageously makes it possible to form a mixture of particles, referred to as secondary particles, of spheroidal shape, of substantially monomodal size distribution and of volume mean diameter between 1 and 50 μm, each of these secondary particles being an agglomerate of a plurality of said primary particles, and having a higher tap density, and a lower specific surface, than the latter.

The mechanisms underlying the occurrence of a controlled agglomeration of the primary particles of the material in the form of spheres of homogeneous size during the carrying out of the shaping step of the method according to the invention will not be prejudged here. However, it may be thought that, during grinding in the mixture of immiscible organic solvents, an emulsion is formed in the medium, droplets of the polar solvent being dispersed in the apolar solvent.

The trapping of the solid primary particles within these droplets of the polar solvent would then cause them to agglomerate into spheres of substantially uniform size.

The method of the invention advantageously makes it possible, by a suitable choice of the operating conditions implemented during the shaping step, to control the size of the secondary particles formed.

These operating conditions can in particular be chosen to obtain a mixture of secondary particles of volume mean diameter less than or equal to 20 μm, facilitating the shaping thereof in the form of an electrode by a conventional coating method.

The volume mean diameter of a mixture of particles, also called D[4,3], is defined in the present description in a conventional manner per se, as the volume-weighted average particle size thereof. This parameter can in particular be determined by analyzing the particulate mixture by the laser diffraction technique, by analyzing the diffraction of the laser light by the particles suspended in a liquid or a gas, by means of any usual laser diffraction granulometer, for example of the Malvern Mastersizer type. The analysis can, for example, be carried out in a liquid medium, in particular on a dispersion of the particles in water, an alcohol or any other solvent, for example at a concentration of about 0.01 to 0.1 mg/ml, this dispersion having optionally been subjected to an ultrasound treatment, for example for 1 minute, for example at a temperature of 25° C., prior to the analysis.

As indicated above, the agglomeration of the primary particles of the cathode material, during the implementation of the shaping step of the method of the invention, makes it possible to reduce the specific surface area of the material and thus limit the reactivity thereof with respect to the surrounding medium, in particular the ambient atmosphere and the electrolyte when it is used within an electrochemical cell.

The cathode material in its form obtained at the end of the method according to the invention has a high tap density, so that the energy density thereof, at the scale of the cell of a battery wherein it is implemented, is much higher than that obtained for the initial mixture of primary particles.

The secondary particles obtained at the end of the method are advantageously less volatile than the initial primary particles, and therefore easier to handle.

The material in its form as obtained at the end of the method according to the invention further has a good cycle life and, generally speaking, good electrochemical performance.

The method according to the invention may further satisfy one or more of the features described hereinafter, implemented alone or in each of the technically effective combinations thereof.

The step of obtaining the cathode material in the form of a mixture of primary particles, each consisting of said material, with a monomodal size distribution and a volume mean diameter less than or equal to 2 μm, can be carried out in any conventional manner.

Depending on the particular material, this mixture of primary particles can, for example, be obtained commercially. Otherwise, it can be synthesized from precursors of the material, in particular by the mechanosynthesis technique, in a manner conventional per se, in particular by grinding suitable precursors, such as LiF, Li₂CO₃, Li₂O, Mn₂O₃, TiO₂, Nb₂O₅, etc., for several tens of hours at high speed, for example greater than 400 rpm, in a ball mill, for example a planetary mill. When the particulate material obtained at the end of the synthesis, in particular mechanosynthesis, step has a multimodal size distribution and/or a volume mean diameter greater than 2 μm, the method according to the invention preferably comprises an additional step of reducing the size of the particles.

Thus, in particular implementations of the invention, particularly adapted to so-called lithium-rich DRS materials, the step of obtaining the cathode material in the form of a mixture of primary particles with a monomodal size distribution and a volume mean diameter less than or equal to 2 μm, comprises:
a step of forming particles of the material by mechanosynthesis, then,
a step of reducing the size of the particles thus formed, in order to obtain the intended mixture of primary particles with a monomodal size distribution and a volume mean diameter less than or equal to 2 μm.

The particle size reduction step can be carried out by any method known to the person skilled in the art. It can in particular be carried out by grinding, for example in a ball mill/agitator, such as a planetary mill. It falls within the competence of a person skilled in the art to choose the operating parameters of such a step according to the specifically targeted particle size distribution. In particular, the grinding may be carried out in a polar solvent, preferably aprotic, such as acetonitrile, or in an apolar solvent, such as cyclohexane.

All these steps are preferably carried out under an inert atmosphere, for example under an argon atmosphere.

The shaping step of the method according to the invention is also preferably carried out under an inert atmosphere, for example under an argon atmosphere.

It can be carried out in any ball mill/agitator conventional per se, for example a planetary mill or a centrifugal mill, provided with a grinding bowl made of inert material, such as zirconia, and grinding balls also formed of inert material, such as zirconia.

The diameter of the grinding balls may be between 3 and 10 mm, for example equal to 3 mm, 5 mm or 10 mm.

The solvents of the mixture of organic solvents implemented in this shaping step are preferably chosen to be inert with respect to the cathode material. For most of the usual cathode materials, this implies that these organic solvents are of the aprotic type. Thus, in particular embodiments of the invention, all the solvents of the mixture of organic solvents implemented according to the invention are aprotic.

The polar or apolar character of an organic solvent is defined here in a conventional way per se, in relation to the dielectric constant of the molecule concerned. Thus, in the present description, an apolar solvent is understood to be a solvent whose dielectric constant is less than 5. A polar solvent is understood to be a solvent whose dielectric constant is greater than or equal to 5.

In particular implementations of the invention, the apolar solvent is chosen in the group consisting of hydrocarbons, in particular C5-C7 hydrocarbons. It is preferably chosen in the group consisting of acyclic hydrocarbons, such as pentane, hexane or heptane, and alicyclic hydrocarbons, such as cyclohexane or cyclopentane.

The mixture of organic solvents may contain one or more apolar organic solvents, each of which may be as defined above.

The mixture of organic solvents may contain one or more organic polar solvents.

Each of these polar solvents is then preferably of the aprotic type.

In preferred implementations of the invention, at least one polar solvent of the mixture of organic solvents is acetonitrile. For example, acetonitrile is the only polar solvent in the mixture of organic solvents.

The mixture of organic solvents implemented according to the invention preferably contains, and more preferably consists of, on the one hand, acetonitrile and, on the other hand, cyclohexane, hexane or heptane.

The volume ratio between the apolar solvent, or the mix of apolar solvents if appropriate, and the polar solvent, or the mix of polar solvents if appropriate, is preferably between 6 and 11, and more preferably between 7 and 10. Such a feature advantageously ensures good control of the morphology of the secondary particles obtained at the end of the shaping step, and in particular the obtaining of a morphology of the spheroidal type, as well as good control of the size of these secondary particles.

A secondary particle size particularly adapted to a use for manufacturing a cathode is obtained by using one or more, preferably all, of the operating parameter values described hereinafter.

In particular implementations of the invention, the duration of the step of shaping the mixture of primary particles by granulation by grinding is between 15 minutes and 5 hours, preferably between 15 minutes and 2 hours, for example between 30 minutes and 1 hour.

The speed of rotation in the ball mill, in the step of shaping the mixture of primary particles by granulation by grinding, is preferably between 100 and 550 rpm, more preferably between 200 and 500 rpm, and for example between 300 and 500 rpm.

Furthermore, preferably, for this shaping step:
the ratio between the mass of the mixture of primary particles and the volume of polar solvent(s) is between 0.5 and 3, in particular between 2 and 3;
and/or the ratio between the mass of grinding balls and the mass of the mixture of primary particles is between 5 and 30, in particular between 15 and 25;
and/or the quantity of grinding balls is between 2 and 10 g/ml of the solvent mixture, for example between 4 and 6 g/ml of the solvent mixture.

In particularly preferred implementations of the invention, the cathode material to which the method of the invention applies comprises, or consists of, an active material of the lithium-rich DRS type. In particular, the cathode material comprises, or consists of, an active material corresponding to the general formula (I):

LiₓM¹_{y}M²_{z}O₃₋ᵤFᵤ (I)
wherein:
x is greater than 1 and less than 3,
y is between 0 and 1,
z is between 0 and 1,
x, y and z being such that x+y+z=3,
u is between 0 and 1, preferably between 0.3 and 1, and for example between 0.5 and 1,
M¹ represents a first transition metal, such as manganese Mn, iron Fe, vanadium V or molybdenum Mo,
and M² represents a second transition metal different from the first transition metal, for example niobium Nb or titanium Ti.

The method according to the invention proves to be highly advantageous in that it makes it possible to prepare, in the form of a mixture of spheroidal secondary particles of substantially monomodal particle size distribution and of controlled micrometric volume mean diameter, a cathode material comprising an active material of general formula (I) for all the values of u, including the values of u greater than or equal to 0.5, and possibly up to 1, this starting from a mixture of primary particles obtained by mechanosynthesis then size reduction, in particular to form particles of nanometric size.

In particular implementations of the invention, in the general formula (I), u is greater than or equal to 0.5 (and less than or equal to 1).

An example of such an active material is the material of formula Li₂MnO₂F.

In alternative implementations of the invention, the cathode material comprises, or consists of, an active material of the lithium iron phosphate (LFP) type, corresponding to the general formula (11):

LiFeₓMn₁₋ₓPO₄ (II)
wherein x is between 0 and 1.

The cathode material may otherwise comprise, or consist of, an active material corresponding to the general formula (III):

AₓM¹[M²(CN)₆] (III)
wherein
A represents lithium Li, sodium Na or potassium K,
M¹ and M², different from each other, each represent manganese Mn or iron Fe, and x is between 0 and 2.

When x is close to 2, such materials are commonly designated as “Prussian whites”.

An example of such a potassium-based material from the Prussian white family is potassium manganese hexacyanoferrate, having the formula (IIIa):

K₂Mn[Fe(CN)₆] (IIIa).

Such a cathode material proves in particular to be useful for manufacturing cathodes of batteries of the potassium-ion type.

As indicated above, the cathode material may consist of a single material, such as the above active materials. Alternatively, it may be a composite material comprising such an active material and an electrically conductive agent.

Thus, in particular implementations of the invention, the cathode material in the form of said mixture of primary particles, obtained in the first step of the method according to the invention, and on which the shaping step of the method is carried out, comprises an electrically conductive agent, preferably based on carbon.

The electrically conductive agents, at least one of whose dimensions is less than 100 nm, are particularly preferred within the scope of the invention.

Mention may be made, as such an electrically conductive agent, of graphite, carbon powder, pyrolytic carbon, carbon black, carbon fibers, carbon microfibers, carbon nanotubes, in particular single-walled or multiple-walled carbon nanotubes, fullerenes, graphene sheets and aggregates of graphene sheets.

Carbon black is particularly preferred within the scope of the invention.

The content of electrically conductive agent in the cathode material may, for example, be between 10 and 20% by weight, relative to the weight of the cathode material.

In the context of the invention, preference will be given to a size of the primary particles formed of the active material, and optionally of the electrically conductive agent, characterized by a volume mean diameter less than or equal to 300 nm, preferably less than or equal to 200 nm, and the operating parameters of the shaping step will preferably be chosen so as to form a mixture of secondary particles formed of the active material, and optionally of the electrically conductive agent, with a volume mean diameter between 1 and 20 μm, preferably between 5 and 20 μm and more preferably between 5 and 15 μm.

It is within the competence of a person skilled in the art to know how to obtain the mixture of primary particles of the desired size, and to determine the operating parameters to be applied in the shaping step in order to obtain the desired secondary particle size. This determination may in particular be carried out empirically.

When the cathode material in the form of a mixture of primary particles with a monomodal size distribution and a volume mean diameter of less than or equal to 2 μm is obtained by a mechanosynthesis method followed by a step of reducing the size of the particles by grinding, preferably, the electrically conductive agent is integrated into the particles during this step of reducing the size by grinding.

Thus, in particular implementations of the invention, the method comprises a step of manufacturing the active material by the mechanosynthesis method, then mixing the particles thus obtained with the electrically conductive agent, such as carbon black, and implementing the grinding step on this mixture, so as to obtain a mixture of primary particles each formed of a composite cathode material, comprising the active material and the electrically conductive agent, with a monomodal size distribution and a volume mean diameter less than or equal to 2 μm.

A cathode material for a battery obtainable at the end of a preparation method according to the invention can comprise, or even consist of, an active material having the general formula (I) above wherein u is greater than or equal to 0.5, the general formula (II) above or the general formula (III) above. This cathode material is in the form of a mixture of spheroidal particles, referred to as secondary particles, with a substantially monomodal size distribution and a volume mean diameter between 1 and 50 μm, preferably between 1 and 20 μm, each of these secondary particles being an agglomerate of a plurality of primary particles originating from a mixture of primary particles of said cathode material of substantially monomodal size distribution and a volume mean diameter less than or equal to 2 μm, preferably less than or equal to 1 μm and more preferably less than or equal to 600 nm.

This cathode material for a battery has all the advantages disclosed above with reference to the cathode material in the form thereof as obtained at the end of the method according to the invention.

This cathode material may in particular comprise, or consist of, the material of formula Li₂MnO₂F.

It may comprise, in addition to the active material having the general formula (I) wherein u is greater than or equal to 0.5, the general formula (II) or the general formula (III), an electrically conductive agent, in particular based on carbon. This electrically conductive agent can have one or more of the features disclosed above with reference to the preparation method according to the invention. It is preferably present in each of the primary particles whose agglomeration forms the secondary particles, just like the active material.

Preferably, the mixture of secondary particles of this cathode material has a volume mean diameter between 1 and 20 μm, preferably between 5 and 20 μm and more preferably between 5 and 15 μm.

Each of the secondary particles is preferably an agglomerate of a plurality of primary particles originating from a mixture of primary particles of said cathode material with a monomodal size distribution and a volume mean diameter less than or equal to 300 nm, preferably less than or equal to 200 nm.

Furthermore, the cathode material has a higher tap density and a lower specific surface area than the mixture of primary particles whose agglomeration formed the secondary particles.

A further object of the invention is a method for manufacturing a cathode for a battery, which comprises:
implementing a method for preparing a cathode material for a battery according to the invention to obtain a cathode material for a battery, this cathode material preferably comprising an active material corresponding to the general formula (I) wherein u is greater than or equal to 0.5, or to the general formula (II) or to the general formula (III), this cathode material being in the form of a mixture of spheroidal so-called secondary particles of monomodal size distribution and of volume mean diameter between 1 and 50 μm, each of these secondary particles being an agglomerate of a plurality of primary particles originating from a mixture of primary particles of the cathode material with a monomodal size distribution and a volume mean diameter less than or equal to 2 μm,
mixing the cathode material thus obtained with a polymer binder, and optionally an electrically conductive agent, in a solvent, so as to form a cathode ink,
depositing this cathode ink on a metal current collector,
and drying this cathode ink to form a cathodic film on the current collector.

Such a method, conventional per se in the general definition thereof, is easy to implement because of the particularly advantageous morphological properties of the cathode material according to the invention, which in particular make it possible to obtain a smooth and homogeneous cathode film on the surface of the current collector.

The method for manufacturing a cathode for a battery according to the invention can be carried out by means of any device conventional per se, and according to operating parameters which are also conventional per se.

By way of examples:
the polymer binder may be polyvinylidene fluoride (PVDF),
the solvent may be 1-methyl-2-pyrrolidone (NMP),
the current collector may be formed of aluminum,
and/or the deposition of the cathode ink on the current collector may be carried out by the coating technique.

As indicated above, an electrically conductive agent, in particular a carbon-based electrically conductive agent, can be integrated into the cathode ink. Such a feature proves particularly advantageous when the cathode material does not comprise such an electrically conductive agent.

The electrically conductive agent incorporated into the cathode ink may have one or more of the features described above with reference to the electrically conductive agent which may be part of the composition of the cathode material to which the invention applies.

The cathode ink may, for example, comprise, by weight relative to the total weight of the cathode ink:
70 to 80%, for example about 75%, of the active material,
10 to 20%, for example about 15%, of electrically conductive agent,
and 5 to 15%, for example about 10%, of the polymer binder.

A cathode for a battery, in particular for a lithium-ion or potassium-ion type battery, obtainable by a method for manufacturing a cathode for a battery according to the invention, comprises a metallic current collector carrying on the surface a cathode film formed from a cathode material obtained according to the invention.

By way of examples:
the current collector may be formed of aluminum,
the cathode film may contain, as polymer binder, polyvinylidene fluoride (PVDF),
the cathode film may contain a content of between 5 and 15%, for example approximately 10%, of polymer binder,
the cathode film may contain 70 to 80%, for example approximately 75%, of an active material of general formula (I) wherein u is greater than or equal to 0.5, of general formula (II) or of general formula (III), in the form of spheroidal secondary particles of monomodal particle size distribution and of volume mean diameter such as defined above,
and/or the cathodic film may contain 10 to 20%, for example about 15%, of electrically conductive agent.

The electrically conductive agent may be contained in the primary particles whose agglomeration forms the secondary particles of the cathode material according to the invention, and/or be present outside these secondary particles, mixed with them.

The cathode for a battery obtained according to the present invention has advantageous electrochemical performances, in particular a good cycle life and a high energy density. It can be implemented in a battery, in particular of the lithium-ion type (for the materials of general formula (I) or of general formula (II)), or of the lithium-ion, sodium-ion or potassium-ion type (for the material of general formula (III)), the other constituent elements of which are moreover conventional per se.

A battery, in particular of the lithium-ion type or of the sodium-ion or potassium-ion type, comprises, in a cell, a cathode for a battery obtained according to the invention, an anode, a separator arranged between this cathode and this anode, and a liquid electrolyte in which this cathode and this anode are immersed.

The liquid electrolyte may be a solution based on a lithium salt, for example lithium hexafluorophosphate LiPF₆.

A method for assembling such a battery comprises inserting the various elements into the cell such that the separator is disposed between the cathode and the anode, and introducing the liquid electrolyte into the cell.

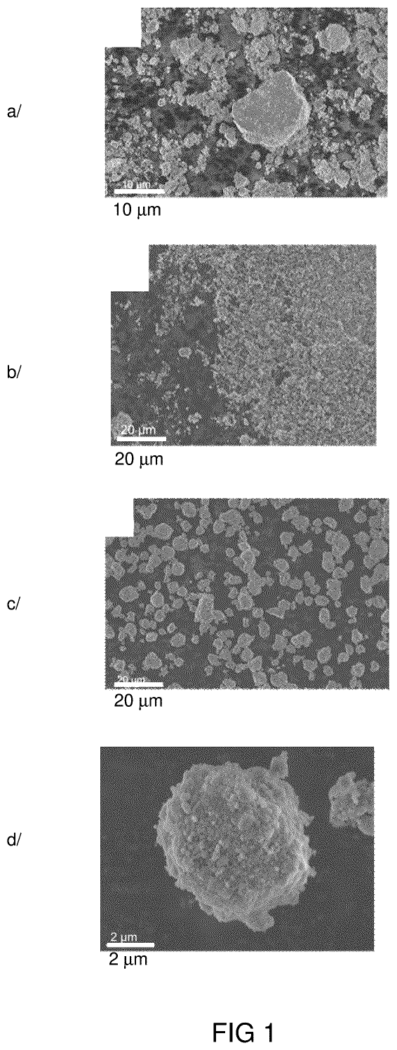

The features and advantages of the invention will become more clearly apparent in light of the examples of implementation below, provided for illustrative purposes only and in no way limiting the invention, with the support of FIGS. 1 to 7, wherein:

FIG. 1 shows scanning electron microscopy images of Li₂MnO₂F particles, in a/, as obtained by mechanosynthesis, in b/, after reduction of the size of these particles by grinding, and in c/ and d/, after shaping in accordance with the invention at two different magnifications.

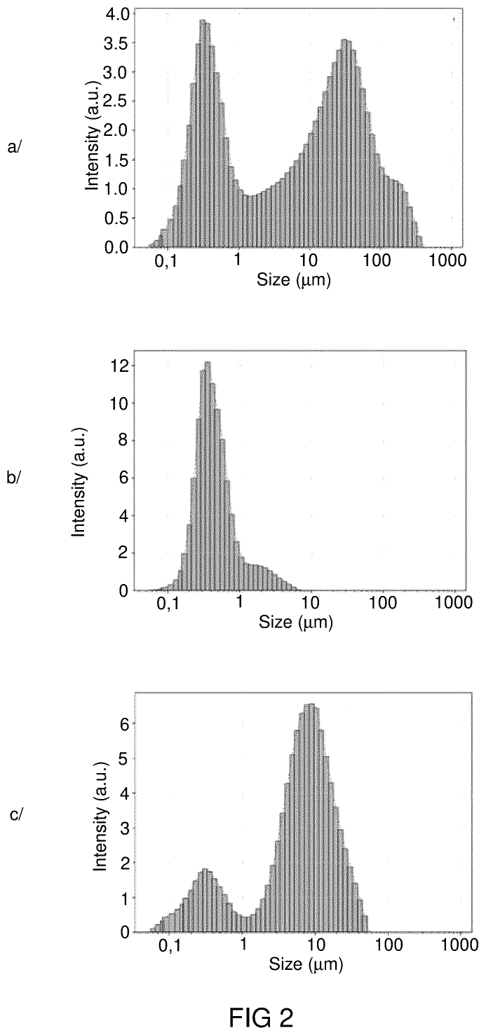

FIG. 2 shows graphs representing the particle size distribution of Li₂MnO₂F, determined by liquid laser granulometry, in a/, for particles as obtained by mechanosynthesis, in b/, after reducing the size of these particles by grinding, and in c/, after shaping in accordance with the invention.

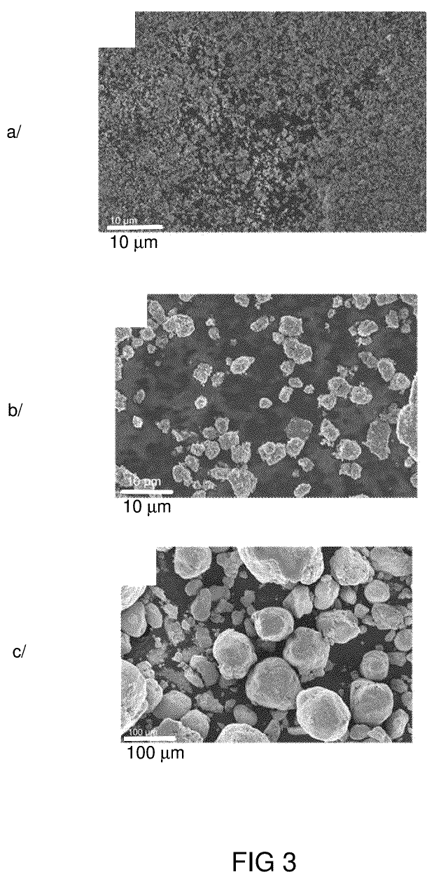

FIG. 3 shows scanning electron microscopy images of particles of a composite of Li₂MnO₂F/carbon, in a/, as obtained after reducing the size of Li₂MnO₂F particles by grinding in the presence of carbon black, and in b/ and c/ after shaping in accordance with the invention, according to various combinations of operating parameters.

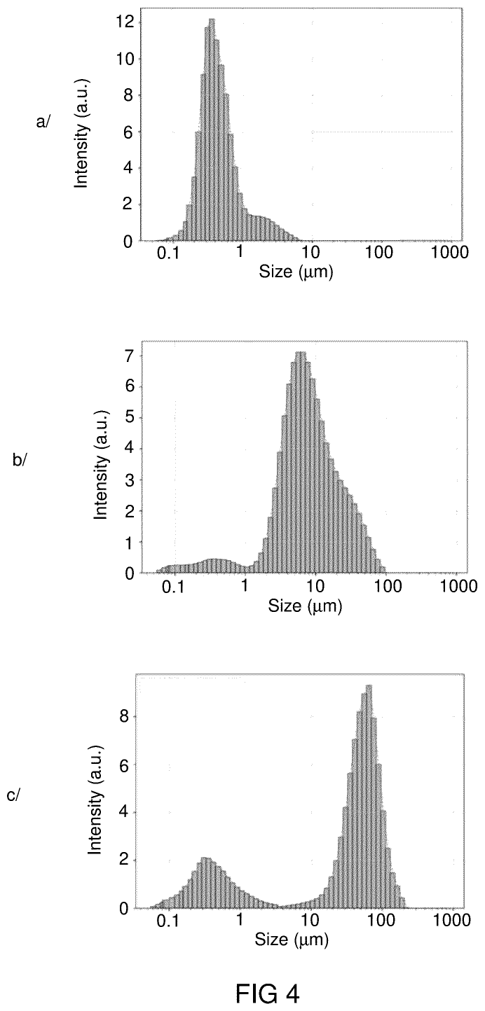

FIG. 4 shows graphs representing the particle size distribution of a composite of Li₂MnO₂F/carbon, determined by liquid laser granulometry, in a/, as obtained after reducing the particle size of Li₂MnO₂F by grinding in the presence of carbon black, and in b/ and c/ after shaping in accordance with the invention, according to various combinations of operating parameters.

FIG. 5 shows scanning electron microscopy images of particles of K₂Mn[Fe(CN)₆], in a/, in the initial state thereof, in b/ and c/, after shaping in accordance with the invention, at two different magnifications.

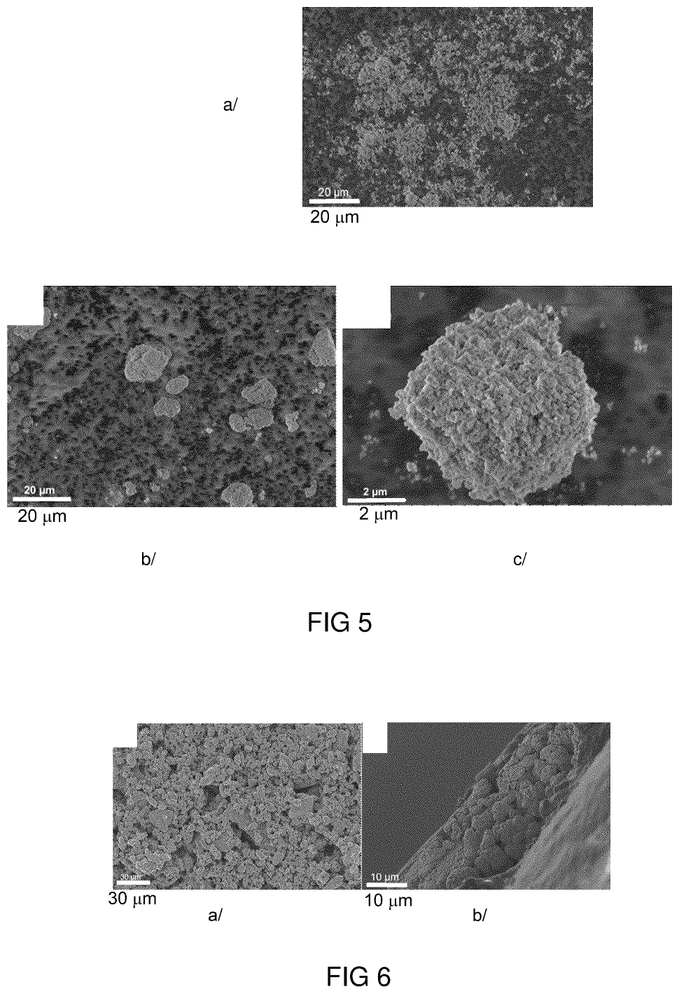

FIG. 6 shows scanning electron microscopy images of an electrode formed based on particles of a composite of Li₂MnO₂F/carbon shaped in accordance with the invention (LMOF/C-g1), in a/, in front view, and in b/, in cross-sectional view.

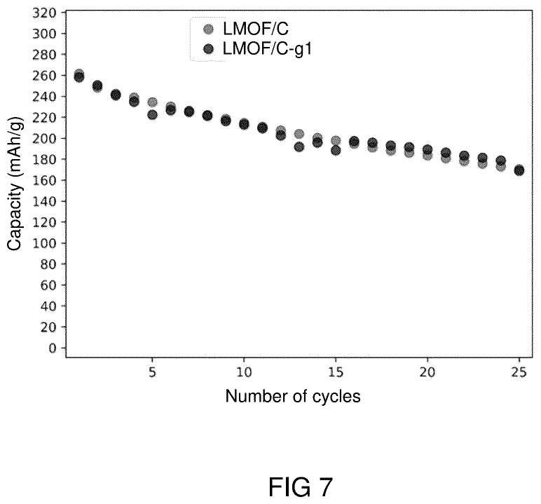

FIG. 7 shows a graph representing the retention capacity of lithium as a function of the number of charge/discharge cycles, obtained by passing on the cycling bench a cell of the button-cell type comprising: as cathode, respectively, an electrode formed based on particles of a composite of Li₂MnO₂F/carbon as obtained by mechanosynthesis (“LMOF/C”), or an electrode formed based on such particles of a composite of Li₂MnO₂F/carbon after shaping in accordance with the invention (“LMOF/C-g1”); as anode, metal lithium; and as electrolyte, LP100.

### A/ Analytical Methods

### A.1/ Scanning Electron Microscopy

Scanning electron microscopy images are acquired on a ZEISS Sigma 300 device, directly in an anhydrous room. The samples are prepared by depositing a small amount (a few mg) of powder on carbon tape. The acceleration voltage of the device for all images is 3 kV. The magnification varies from X500 to X20,000.

### A.2/ Determination of the Particle Size Distribution

The particle size distribution is measured using a Malvern Mastersizer wet laser diffraction particle size analyzer. The particles are previously dispersed in water at about 0.1 mg/mL and the dispersion obtained is subjected to ultrasounds for 1 min at 25° C.

### A.3/ Measurement of the Tap Density

The measurements are carried out by means of a Matec densi-tap DEN 100 device. A known mass of powder (about 2 g) is introduced into a 10 mL test tube. The powder is densified by mechanically tapping the test tube 10,000 times. The volume is then read on the test tube in order to calculate the tap density. The device used is: Matec Densi-tap DEN 100.

### A.4/ Measurement of the Specific Surface Area

The specific surface area is determined by the so-called BET (Brunauer-Emmett-Teller) measurement, by nitrogen adsorption, using a TriStar II 3020 device from Micromeritics.

All the experiments below are carried out under an inert atmosphere in a glove box.

B/ Experiment 1—Li₂MnO₂F

### B.1/ Step 1—Preparation by Mechanosynthesis

The reference material, pristine, of chemical formula Li₂MnO₂F, is first synthesized by mechanosynthesis from three precursors Li₂O, LiF and Mn₂O₃, implemented in stoichiometric proportions. The precursors are dry ground for several tens of hours in a planetary mill using zirconia balls.

The material thus obtained is referred to hereinafter as LMOF-p.

### B.2/ Step 2—Size Reduction by Grinding

The particle size of the LMOF-p material is reduced by a first grinding.

For this purpose, the following are added to a 50 mL zirconia bowl:
2 g of LMOF-p,
30 g of zirconia balls 5 mm in diameter,
and 5 mL of cyclohexane.

The above mixture is ground for several hours at 450 rpm.

At the end of this step, a ground material is obtained, which is hereinafter referred to as LMOF-b.

B.3/ Step 3—Shaping in Accordance with the Invention

The following are added to a 50 ml zirconia grinding bowl:
2 g of LMOF-b,
5 mL of cyclohexane,
0.7 mL of acetonitrile,
10 (10 mm zirconia balls) (about 30 g).

This preparation is made in a glove box and the grinding bowl is sealed under argon.

This mixture is ground using a Retsch® PM 100 CM centrifugal grinder for 30 min at 300 rpm. After drying and separating the balls, a shaped material is obtained, hereinafter referred to as LMOF-g.

### B.4/ Analyses

The particulate materials obtained at the end of each of the steps 1, 2 and 3 above are analyzed by observation by scanning electron microscopy (SEM) and laser granulometry, and their tap density is determined.

The SEM images are shown in FIG. 1, in a/ for the LMOF-p material obtained at the end of step 1, in b/ for the LMOF-b material obtained at the end of step 2, and in c/ and d/ for the LMOF-g material obtained at the end of step 3. The size distribution profiles are shown in FIG. 2, in a/ for the LMOF-p material obtained at the end of step 1, in b/ for the LMOF-b material obtained at the end of step 2, and in c/ for the LMOF-g material obtained at the end of step 3.

It is observed that the LMOF-p material obtained at the end of step 1 comprises nanometric pulverized particles, as well as micronic aggregates. These aggregates larger than 30 μm are not compatible with industrial coating processes.

The LMOF-b material obtained at the end of step 2 comprises particles of relatively homogeneous nanometric size, with a particle size distribution concentrated between 0.1 and 10 μm.

It can be seen in FIG. 1 that the LMOF-g shaped material is in the form of spherical secondary particles, each composed, as can be seen in d/ in the figure, of nanometric primary grains. Some particles have a platelet appearance. As shown in FIG. 2, the size distribution is quasi-monomodal (the presence of the peak at sizes smaller than 1 μm on the graph being attributable to a degradation of a small part of the particles during the ultrasound treatment implemented for the analysis). The D[4,3] of the material is 10.63 μm.

Table 1 below indicates, for each of the LMOF-p, LMOF-b and LMOF-g materials, the observed morphological features, the particle size distribution (expressed by the parameter D[4,3]) and the measured tap density.

TABLE 1
Pristine materials features

| | | Particle size | Tap density |
|---|---|---|---|
| Material | Morphology | D[4, 3] (μm) | (g/cm³) |
| LMOF-p | Uncontrolled aggregates of | 27.53 | 1.4 |
| | nanoparticles | | |
| LMOF-b | Pulverized nanoparticles | 0.58 | 0.7 |
| LMOF-g | Spherical (micronic) | 10.63 | 0.85 |
| | aggregates of nanoparticles | | |

These results demonstrate that the LMOF-g material obtained in accordance with the invention has a morphology and taped density that are particularly suitable for an implementation for manufacturing cathodes for batteries.

C/ Experiment 2—Li₂MnO₂F/C
C.1/ Step 2—Preparation of Li₂MnO₂F/C with Size Reduction by Grinding

A Li₂MnO₂F/carbon composite material is synthesized by grinding from the LMOF-p material prepared in step 1 of Experiment 1, according to the following detailed protocol. The following are added in a 50 mL zirconia grinding bowl:
833 mg of the LMOF-p material as prepared in Experiment 1,
167 mg of carbon black C65,
5 ml of cyclohexane,
and 30 g of zirconia balls 5 mm in diameter.

The grinding bowl is sealed under an inert atmosphere, and the grinding is carried out by means of a Retsch® PM 100 CM centrifugal grinder for 5 hours effective at 450 rpm.

The material obtained is referred to hereinafter as LMOF/C.

C.2/ Step 3a—Shaping by a Method According to the Invention (Variant 1)

The following are added to a 50 ml zirconia grinding bowl:
2 g of LMOF/C,
5 mL of cyclohexane,
0.7 mL of acetonitrile,
10 (10 mm zirconia balls) (about 30 g).

This preparation is made in a glove box and the grinding bowl is sealed under argon.

This mixture is ground using a Retsch® PM 100 CM centrifugal grinder for 1 h at 300 rpm. After drying and separating the balls, a shaped material is obtained, hereinafter referred to as LMOF/C-g1.

C.3/ Step 3b—Shaping by a Method According to the Invention (Variant 2)

The following are added to a 50 ml zirconia grinding bowl:
2 g of LMOF/C,
5 mL of cyclohexane,
0.7 mL of acetonitrile,
10 (10 mm zirconia balls) (about 30 g).

This preparation is made in a glove box and the grinding bowl is sealed under argon.

This mixture is ground using a Retsch® PM 100 CM centrifugal grinder for 30 min at 500 rpm. After drying and separating the balls, a shaped material is obtained, hereinafter referred to as LMOF/C-g2.

### C.4/ Analyses

The particulate materials obtained at the end of each of the steps 2, 3a and 3b above are analyzed by observation by scanning electron microscopy (SEM) and by laser granulometry, and their tap density and the specific surface area of the particles are determined.

The SEM images are shown in FIG. 3, in a/ for the LMOF/C material obtained at the end of step 2, in b/ for the LMOF/C-g1 material obtained at the end of step 3a, and in c/ for the LMOF/C-g2 material obtained at the end of step 3b. The size distribution profiles are shown in FIG. 4, in a/ for the LMOF/C material obtained at the end of step 2, in b/ for the LMOF/C-g1 material obtained at the end of step 3a, and in c/ for the LMOF/C-g2 material obtained at the end of step 3b.

It is observed that the LMOF/C material obtained at the end of step 2 comprises pulverized particles of nanometric size, with a particle size distribution between 0.1 and 10 μm.

It is observed in FIGS. 3 and 4 that:
the shaped material LMOF/C-g1 is in the form of spheroidal particles of about 15 μm in diameter, with a D[4,3] that is 11.27 μm—the size distribution is quasi-monomodal;
the shaped material LMOF/C-g2 is in the form of spheroidal particles of about 50 μm in diameter, with a D[4,3] that is 43 μm—the size distribution is quasi-monomodal.

Table 2 below indicates, for each of the materials LMOF/C, LMOF/C-g1 and LMOF/C-g2, the observed morphological features, the particle size distribution (expressed as parameter D[4,3]) and the measured tap density, as well as the specific surface area of the particles.

TABLE 2
Features of pristine/carbon composite materials

| | | | | Specific |
|---|---|---|---|---|
| | | | Tap | surface |
| | | Particle size | density | area |
| Material | Morphology | D[4, 3] (μm) | (g/cm³) | (m²/g) |
| LMOF/C | Pulverized nanoparticles | 2 | 0.6 | 43 |
| LMOF/C-g1 | Spherical (micronic) | 11 | 0.8 | 38 |
| | aggregates of | | | |
| | nanoparticles | | | |
| LMOF/C-g2 | Spherical (micronic) | 43 | 1.15 | 30 |
| | aggregates of | | | |
| | nanoparticles | | | |

A decrease in the specific surface area and an increase in the tap density are observed at the end of the shaping step according to the invention, both in the variant 1 (step 3 a) thereof and in the variant 2 (step 3b) thereof.

D/ Experiment 3—K₂Mn[Fe(CN)₆]

This experiment implements Prussian white potassium, of chemical formula K₂Mn[Fe(CN)₆], as starting material.

D.1/ Shaping in Accordance with the Invention

The following are added to a 50 ml zirconia grinding bowl:
1.2 g of K₂Mn[Fe(CN)₆]
6 mL of cyclohexane,
0.6 mL of acetonitrile,
3 (10 mm zirconia balls) (about 30 g).

This preparation is made in a glove box and the grinding bowl is sealed under argon.

This mixture is ground using a Retsch® PM 100 CM planetary mill for 1 h at 300 rpm. After drying and separating the balls, a shaped material is obtained.

### D.2/ Analysis

The initial particulate material and that obtained at the end of the shaping step are analyzed by scanning electron microscopy (SEM) observation.

The SEM images are shown in FIG. 5, in a/ for the initial material, and in b/ and c/ for the material shaped in accordance with the invention, at two different magnifications (respectively, x1,000 and x10,000).

It is observed that in the initial state thereof, Prussian white potassium K₂Mn[Fe(CN)₆] has a morphology characterized by the presence of nanoparticles, and that there is therefore an interest in shaping it in accordance with the invention, in order to increase the density thereof and reduce the reactivity thereof. The D[4,3] thereof is 1 μm and the particle size distribution thereof is monomodal.

The shaped material, shown in b/ and c/ in FIG. 5, comprises for its part substantially spherical secondary particles, each composed, as visible in c/, of nanometric primary grains.

### E/ Experiment 4—Electrode Made of LMOF/C Composite Material

The following are used for this experiment: the LMOF/C composite material as obtained at the end of step 2 of Experiment 2, and the Li₂MnO₂F/carbon composite material shaped in accordance with the invention, LMOF/C-g1, as obtained at the end of step 3a of Experiment 2.

Each of these materials is shaped as an electrode according to the following protocol. A cathode ink is formulated by dispersing the material (LMOF/C or LMOF/C-g1) and PVDF (polyvinylidene fluoride) in a solvent, NMP (1-methyl-2-pyrrolidone). This ink is coated on an aluminum current collector directly in the glove box.

The final mass composition of the electrodes is as follows: 75% active material (Li₂MnO₂F), 15% of C65 carbon and 10% of PVDF binder. Pellets 14 mm in diameter are cut, and calendered to 10 t using a press. The weight of the electrodes obtained is in the order of 1 mg/cm².

FIG. 6 shows SEM acquired images of such an electrode formed from LMOF/C-g1, in a/ in front view, and in b/ in cross-sectional view. These images confirm that the electrode preparation technique did not damage the secondary particles formed by the method according to the invention.

The electrochemical performances of these electrodes are evaluated as follows. Button cells are assembled in a glove box, in a conventional way per se, using for each:
as positive electrode (cathode), either such an electrode based on LMOF/C-g1 (cathode according to the invention Ci), or such an electrode based on LMOF/C (comparative cathode Cc),
as negative and reference electrode, metal lithium,
as separator, a Celgard® 2400 membrane,
as electrolyte, LP100 (1M LiPF₆ in EC/PC/DMC 1/1/3 vol. %, where EC designates ethylene carbonate, PC designates propylene carbonate and DMC designates dimethyl carbonate).

The button cells are assembled in a glove box, under argon, in batches of three to ensure reproducibility.

The performances of the batteries thus formed are tested on an Arbin cycling bench. The applied current corresponds to a C/10 C-rate, using 300 mA·h/g as theoretical capacitance. The potential cycling terminals are 1.5 V and 4.8 V.

The results obtained, in terms of lithium retention capacity as a function of the number of charge/discharge cycles applied, are shown in FIG. 7. It is observed that the performances of the material shaped according to the invention (LMOF/C-g1) are equivalent to that of the nanometric composite material (LMOF/C), the material shaped according to the invention also having the advantages of a higher tap density and therefore a higher energy density.

1. A method for preparing a cathode material for a battery, comprising obtaining said cathode material in the form of a mixture of so-called primary particles, of monomodal size distribution and volume mean diameter, determined by laser diffraction, less than or equal to 2 μm, then comprising a step of shaping said mixture of primary particles by granulation by grinding in a ball mill, in a mixture of organic solvents comprising a polar organic solvent and an apolar organic solvent, said polar organic solvent and said apolar organic solvent being immiscible.

2. The method as claimed in claim 1, wherein said apolar solvent is selected in the group consisting of hydrocarbons.

3. The method as claimed in claim 2, wherein said apolar solvent is selected in the group consisting of acyclic hydrocarbons and alicyclic hydrocarbons.

4. The method as claimed in claim 1, wherein said polar solvent is of the aprotic type.

5. The method as claimed in claim 4, wherein said polar solvent is acetonitrile.

6. The method as claimed in claim 1, wherein the volume ratio between said apolar solvent and said polar solvent is between 6 and 11.

7. The method as claimed in claim 1, wherein the duration of said step of shaping said mixture of primary particle by granulation by grinding is between 15 minutes and 5 hours.

8. The method as claimed in claim 1, wherein the rotational speed in said ball mill in said step of shaping said mixture of primary particle by granulation by grinding is between 100 and 550 rpm.

9. The method as claimed in claim 1, wherein said cathode material comprises an active material corresponding to the general formula (I):
LiₓM¹_{y}M²_{z}O₃₋ᵤFᵤ (I)
wherein:
x is greater than 1 and less than 3,
y is between 0 and 1,
z is between 0 and 1,
x, y and z being such that x+y+z=3,
u is between 0 and 1,
M¹ represents a first transition metal,
and M² represents a second transition metal different from said first transition metal.

10. The method as claimed in claim 9, wherein in the general formula (I) u is greater than or equal to 0.5.

11. The method as claimed in claim 1, wherein said cathode material comprises an active material corresponding to the general formula (11):
LiFeₓMn₁₋ₓPO₄ (II)
wherein x is between 0 and 1.

12. The method as claimed in claim 1, wherein said cathode material comprises an active material corresponding to the general formula (III):
AₓM¹[M²(CN)₆] (III)
wherein
A represents lithium, sodium or potassium,
M¹ and M², different from each other, each represent manganese or iron, and x is between 0 and 2.

13. The method as claimed in claim 1, wherein said cathode material comprises an electrically conductive agent.

14. A method for manufacturing a cathode for a battery, comprising:
implementing a method as claimed in claim 10 to obtain a cathode material for a battery comprising an active material corresponding to the general formula (I) wherein u is greater than or equal to 0.5, said cathode material being in the form of a mixture of so-called spheroidal secondary particles of monomodal size distribution and of volume mean diameter between 1 and 50 μm, each of said secondary particles being an agglomerate of a plurality of primary particles originating from a mixture of primary particles of said cathode material with a monomodal size distribution and a volume mean diameter less than or equal to 2 μm,
mixing said cathode material with a polymer binder, and optionally an electrically conductive agent, in a solvent, so as to form a cathode ink,
depositing said cathode ink on a metal current collector,
and drying said cathode ink to form a cathodic film on said current collector.

15. A method for manufacturing a cathode for a battery, comprising:
implementing a method as claimed in claim 11 to obtain a cathode material for a battery comprising an active material corresponding to the general formula (II), said cathode material being in the form of a mixture of so-called spheroidal secondary particles of monomodal size distribution and of volume mean diameter between 1 and 50 μm, each of said secondary particles being an agglomerate of a plurality of primary particles originating from a mixture of primary particles of said cathode material with a monomodal size distribution and a volume mean diameter less than or equal to 2 μm,
mixing said cathode material with a polymer binder, and optionally an electrically conductive agent, in a solvent, so as to form a cathode ink,
depositing said cathode ink on a metal current collector,
and drying said cathode ink to form a cathodic film on said current collector.

16. A method for manufacturing a cathode for a battery, comprising:
implementing a method as claimed in claim 12 to obtain a cathode material for a battery comprising an active material corresponding to the general formula (III), said cathode material being in the form of a mixture of so-called spheroidal secondary particles of monomodal size distribution and of volume mean diameter between 1 and 50 μm, each of said secondary particles being an agglomerate of a plurality of primary particles originating from a mixture of primary particles of said cathode material with a monomodal size distribution and a volume mean diameter less than or equal to 2 μm,
mixing said cathode material with a polymer binder, and optionally an electrically conductive agent, in a solvent, so as to form a cathode ink,
depositing said cathode ink on a metal current collector,
and drying said cathode ink to form a cathodic film on said current collector.
